(19) United States
(12) Patent Application Publication
(10) Pub. No.: US 2025/0026272 A1
(43) Pub. Date: Jan. 23, 2025

(54) Vehicle Rock Step Assembly and Method

(71) Applicant: Advanced Flow Engineering, Inc., Corona, CA (US)

(72) Inventors: Shahriar Nick Niakan, Anaheim Hills, CA (US); Saul Zambrano, Corona, CA (US); John Gray, Corona, CA (US)

(21) Appl. No.: 18/780,455

(22) Filed: Jul. 22, 2024

Related U.S. Application Data
(60) Provisional application No. 63/514,651, filed on Jul. 20, 2023.

(51) Int. Cl. B60R 3/00; B60R 19/42

(52) U.S. Cl. CPC B60R 3/002; B60R 19/42

(57) ABSTRACT

Rock slider and rock step assemblies are often desired additions for off-road vehicles, as they can provide both protection and functionality. Rock sliders assemblies described herein can be constructed from high-strength materials like reinforced steel or aluminum, shield the vehicle's lower body and undercarriage from impacts with rocks and other obstacles. They can distribute the force of collisions, preventing damage to critical components. Similarly, rock step assemblies can offer convenient access to the vehicle while being durable enough to withstand harsh off-road conditions. These assemblies can utilize advanced mounting systems that avoid drilling, preserving the vehicle's structural integrity and warranty. Some embodiments can utilize reinforced materials to ensure resilience against physical stresses and corrosion. By combining robust protection with practical utility, one-piece or two-piece rock slider and step assemblies can enhance the off-road capabilities of cars, trucks, SUVs, and jeeps, allowing adventurers to navigate challenging terrains confidently.

The present disclosure relates to vehicle rock step and rock slider assemblies. More particularly, the present disclosure relates to vehicle rock steps and sliders that couple to existing holes of a vehicle and provide improved ground clearance.

### BACKGROUND

In recent years, there has been a noticeable increase in the number of people venturing off-road and engaging in overlanding adventures using a variety of vehicles such as cars, trucks, SUVs, and jeeps. This trend can be attributed to the desire for exploration, a closer connection with nature, and the thrill of conquering challenging terrains. Whether it is embarking on remote camping trips, exploring scenic trails, or simply seeking an escape from the urban hustle, more individuals are embracing off-road experiences, pushing the limits of their vehicles, and immersing themselves in the great outdoors.

Going off-road presents many challenges for vehicles, no matter the size or shape, and especially if such vehicles include side steps. One significant issue is the potential for obstacle damage. Side steps, especially those that hang low or extend beyond the vehicle's body, are susceptible to hitting curbs, speed bumps, rocks, or other objects on the road. This can result in significant damage to the side steps, including bending or breaking them, which not only affects their functionality but also detracts from the vehicle's overall appearance.

Another problem arises from the need to drill holes in the vehicle's frame or body to mount the side steps securely. This process can weaken the structural integrity of the car or truck, making it more vulnerable to damage in the event of a collision or impact. Moreover, drilling holes can potentially void the manufacturer's warranty, leaving the owner responsible for any subsequent repairs or modifications.

### BRIEF DESCRIPTION OF DRAWINGS

The description of the present disclosure will be more fully understood with reference to the following figures, which are presented as exemplary embodiments of the disclosure and should not be construed as a complete recitation of the scope of the disclosure, wherein:

FIG. 1 is an isometric view of a rock step assembly in accordance with various embodiment of the disclosure;

FIG. 2 is a side perspective view of a rock step assembly in accordance with various embodiment of the disclosure;

FIG. 3 is a side perspective view of a rock step assembly in accordance with various embodiment of the disclosure;

FIG. 4 is a lower perspective view of a rock step assembly in accordance with various embodiment of the disclosure;

FIG. 5 is a cross-sectional view of a rock step assembly in accordance with various embodiment of the disclosure;

FIG. 6 is an isometric view of a rock slider assembly in accordance with various embodiment of the disclosure;

FIG. 7 is a side perspective view of a rock slider assembly in accordance with various embodiment of the disclosure;

FIG. 8 is a side perspective view of a rock slider assembly in accordance with various embodiment of the disclosure;

FIG. 9 is a lower perspective view of a rock slider assembly in accordance with various embodiment of the disclosure; and

FIG. 10 is a cross-sectional view of a rock slider assembly in accordance with various embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, devices and methods are discussed herein for a vehicle rock step that provides a practical alternative to traditional methods by minimizing the impact on ground clearance while replacing the existing plastic cladding on the vehicle. By doing so, it offers enhanced durability and protection to the vehicle's rocker panels, safeguarding against potential damage when navigating challenging terrains.

In some embodiments, the vehicle rock step assembly involves the fabrication of protective components using either sheet metal or a combination of tubular and sheet metal construction. These materials are selected for their strength and resilience, ensuring long-lasting performance.

In some embodiments, the existing holes in the vehicle in combination with expandable threaded inserts, which may be securely fastened to the vehicle's frame. This approach not only simplifies the installation process but also maintains the structural integrity of the vehicle, eliminating the need for additional drilling or modifications.

It should be appreciated that in some embodiments, superior ground clearance is realized, ensuring that the rocker panel protection has minimal overhang below the lower pinch weld seam on unibody vehicles. As such, drivers may confidently traverse uneven terrain without fear of damaging or scraping the protective components.

Additionally, in some embodiments, pinch seam protection is also provided, particularly in vulnerable areas between a vehicle's axles, for example. By fortifying one or more of these sections, embodiments as disclosed herein are configured to effectively shield against potential obstacles encountered during off-road adventures, further preserving the vehicle's integrity, and preventing costly damage.

In some embodiments, a platform for accessing roof-mounted cargo is provided, which offers a secure and stable footing when loading or unloading equipment or gear. This accessibility is especially valuable for those engaging in overlanding trips, where efficient utilization of space and easy access to stored items are essential for a successful adventure.

In many embodiments, rock sliders are components designed to protect a vehicle's lower body and undercarriage during off-road adventures. They are typically constructed from high-strength materials such as reinforced steel or aluminum and are mounted along the sides of the vehicle, below the doors. Rock sliders act as a protective barrier, distributing the force of impacts from rocks, curbs, and other obstacles across a larger area. This prevents direct damage to the vehicle's bodywork and components. By absorbing and deflecting impacts, rock sliders help maintain the structural integrity and appearance of off-road vehicles, enabling them to traverse challenging terrains with reduced risk of damage.

In a number of embodiments, side steps are accessories installed on the sides of vehicles to assist passengers in entering and exiting, especially useful for higher off-road vehicles such as trucks and SUVs. Traditional side steps often hang low or extend outward from the vehicle's body, which can make them vulnerable to damage during off-road excursions. Modern designs, like those found in rock step assemblies, integrate the utility of side steps with enhanced durability and protection features. These steps are crafted to endure harsh conditions, providing both convenience and resilience against impacts with obstacles encountered in off-road environments.

In additional embodiments, mounting systems for off-road accessories like rock sliders and side steps are engineered to ensure secure attachment without compromising the vehicle's structural integrity. Traditional mounting methods often involve drilling into the vehicle's frame or body, which can weaken the structure and void manufacturer warranties. Innovative mounting systems described herein can utilize existing mounting points or employ non-invasive techniques that do not require drilling. These systems ensure that accessories are firmly attached and capable of withstanding the rigors of off-road use, while preserving the vehicle's warranty and structural soundness.

Reinforced materials used in the construction of off-road components like rock sliders and side steps are essential for their durability and performance. Commonly used materials include high-strength steel and aluminum alloys, often enhanced with treatments or coatings to resist corrosion and wear. Reinforcement ensures that these components can absorb and dissipate significant forces from impacts without bending, cracking, or breaking. The use of reinforced materials is crucial in off-road applications where components are regularly exposed to harsh conditions and physical stresses.

Non-invasive installation can allow for the mounting of vehicle accessories such as rock sliders and side steps without drilling or permanently altering the vehicle's frame or body. This method can utilize existing mounting points or specially designed brackets that allow for secure attachment. Non-invasive installation techniques are often preferred because they can maintain the vehicle's structural integrity and do not void manufacturer warranties. This approach ensures that modifications can be made safely and effectively, providing the benefits of added protection and functionality without compromising the vehicle's original design and warranty conditions.

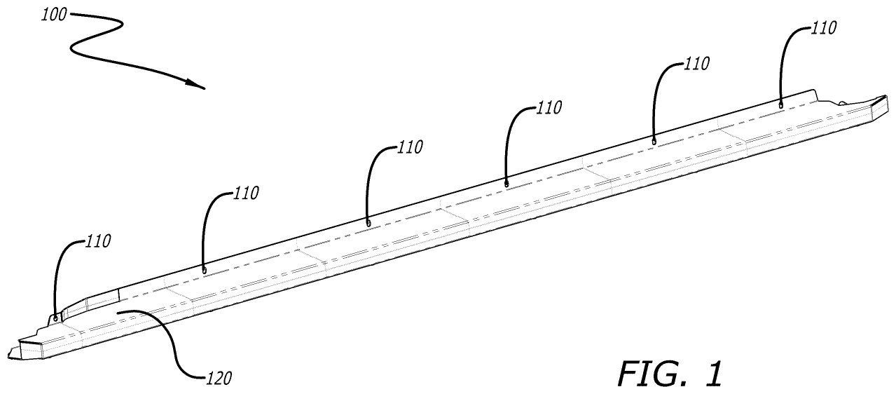

Referring to FIG. 1, an isometric view of a rock step assembly 100 in accordance with various embodiments of the disclosure is shown. In some embodiments, the rock step assembly 100 is configured for attaching to an area generally beneath the doors of a vehicle, using one or more mounting locations. The number of mounting locations required, such as the upper mounting locations 110 depicted in FIG. 1, may vary depending on the specific make and model of the vehicle. In some embodiments, the rock step assembly 100 provides a secure and convenient platform 120, providing users with a stable surface to place their foot or step onto when entering or exiting the vehicle.

In some embodiments, several drainage openings (not shown) are strategically disposed along one or more surfaces of the rock step assembly 100. These drainage openings serve a dual purpose: facilitating water drainage and allowing for the passage of other elements. This ensures that water, mud, or debris accumulated on the rock step assembly 100 can be efficiently drained, preventing accumulation and maintaining a clean and slip-resistant surface. It should be appreciated that the number of openings can be customized according to the specific needs and preferences of the user or vehicle, without limitation.

In addition to its functional platform 120 and drainage openings, the vehicle rock step assembly 100 may also include a lower pinch seam protection element (not shown). In some embodiments, the protective element spans the entire length of the rock step, providing a shield for the vulnerable pinch seam area. By fortifying this region, the rock step assembly 100 can effectively safeguard against potential damage caused by obstacles encountered during off-road or adventurous driving. It is envisioned that the pinch seam protection enhances the overall durability and longevity of the vehicle while ensuring that crucial structural components remain intact.

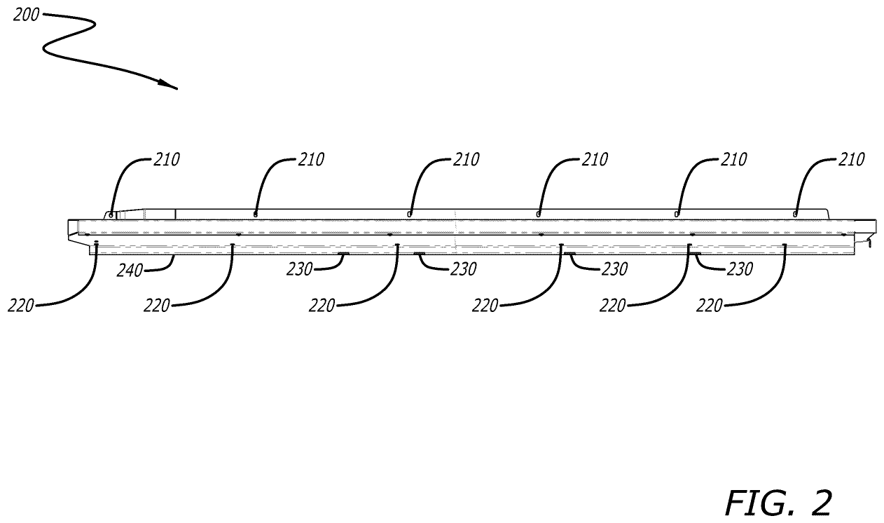

Referring to FIG. 2, a side perspective view of a rock step assembly 200 in accordance with various embodiments of the disclosure is shown. In some embodiments, the rock step assembly 200 is configured to offer a wide range of mounting options, accommodating both upper and lower mounting locations. These locations may be based on original equipment manufacturer (OEM) locations provided by the vehicle, ensuring a secure and compatible fit. Depending on the specific vehicle or intended use, not all the mounting locations need to be utilized. This flexibility allows for customization, as the rock step assembly 200 can be installed with fewer or more mounting locations depending on the specific requirements or preferences of the user.

In some embodiments, the rock step assembly 200 features draining openings 230 strategically placed between the upper mounting locations 210 and lower mounting locations 220. An additional pinch seam protection element 240 may be included. However, it is important to note that these openings can be positioned anywhere on the assembly as per the desired specification. In general, the purpose of these openings is to facilitate efficient water drainage and the passage of other elements. This ensures that any water, mud, or debris accumulated on the rock step assembly can be effectively drained, maintaining a clean and slip-resistant surface. By offering the flexibility to position the draining openings 230 at various locations, the rock step assembly 200 can be adapted to different vehicle models and user preferences.

It should be appreciated that the size and shape of the draining openings 230 may be varied without limitation. For example, larger or more numerous openings can be incorporated to enable faster drainage or accommodate larger debris, while smaller or fewer openings can be utilized to prevent the passage of certain elements. This flexibility can ensure that the rock step assembly 200 can be tailored to provide the desired level of drainage while considering factors such as environmental conditions, terrain, and user requirements.

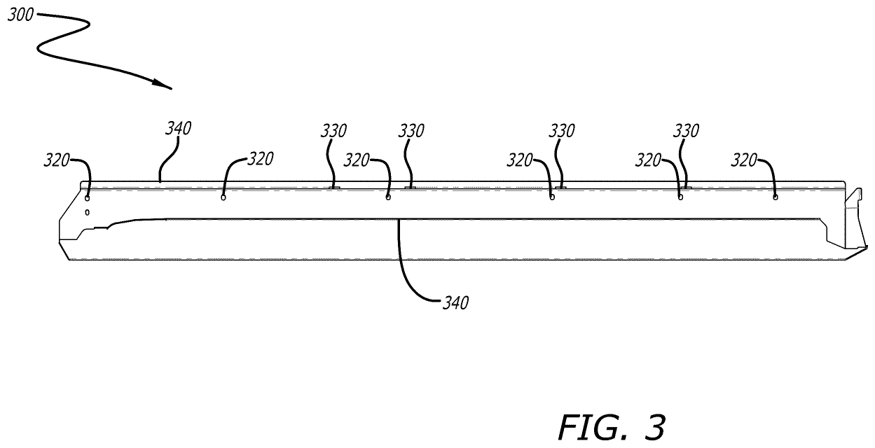

Referring to FIG. 3, a side perspective view of a rock step assembly 300 in accordance with various embodiments of the disclosure is shown. A plurality of upper mounting locations 310, lower mounting locations 320, and drainage openings 330 can be disposed along the rock step assembly 300. In some embodiments, the lower edge of the rock step assembly 300 may be configured to wrap around a pinch seam of the vehicle. A pinch seam, also known as a rocker panel seam, generally refers to the area where the body panels of a car or truck come together, typically located along the lower edge of the vehicle's side. It is a structural feature that helps maintain the vehicle's integrity and rigidity.

Those skilled in the art will appreciate that wrapping the pinch seam with a pinch seam protection element 340 of the rock step assembly 300 offers several benefits. First, it provides added protection to the pinch seam, which is vulnerable to damage when navigating off-road terrain or encountering obstacles. By covering and reinforcing this area, the rock step assembly 300 can help shield the pinch seam from impacts, scrapes, and potential deformation. Moreover, wrapping the pinch seam with the rock step assembly 300 via the pinch seam protection element 340 can enhance the overall durability of the vehicle. The assembly acts as a barrier, minimizing the risk of debris, rocks, or other objects getting lodged or caught in the pinch seam. This reduces the chances of corrosion, rust, or other damage that could compromise the structural integrity of the vehicle over time. Additionally, the wrapped pinch seam may contribute to the aesthetic appeal of the vehicle. It can create a seamless and cohesive appearance, blending the rock step assembly 300 into the overall design of the vehicle. This integration can enhance the visual appeal while providing functional benefits, making it a desirable feature for car and truck owners, without limitation.

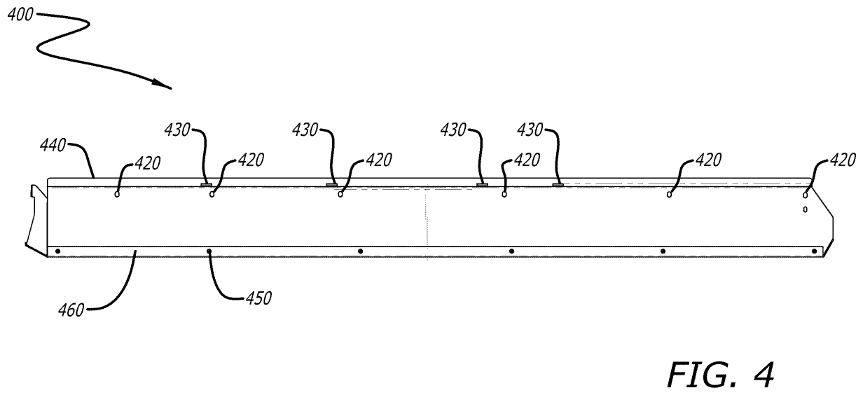

Referring to FIG. 4, a lower perspective view of a rock step assembly 400 in accordance with various embodiments of the disclosure is shown. In some embodiments, the rock step assembly 400 offers flexibility in its construction, available in both multi-piece and one-piece configurations. In a two-piece construction, for example, the rock step assembly may include separate components that are configured to couple together seamlessly. These components may overlap in certain regions, allowing for the use of two-piece fasteners 450 such as bolts or screws through pre-drilled holes. The design of including a two-piece overlap portion 460, which can be disposed along the length of the rock step assembly 400 can ensure a secure and sturdy connection between the different parts of the rock step assembly.

In some embodiments, a one-piece construction may comprise a single unit that is fabricated or molded as a continuous piece. This potentially eliminates the need for separate components and further simplifies the installation process. In the case of one-piece construction, the assembly may still feature pre-drilled holes to accommodate fasteners or mounting hardware. Whether it is a two-piece or one-piece construction, the overlapping areas and pre-drilled holes in the rock step assembly can facilitate the secure attachment of the assembly to the vehicle's frame or body. This allows for a robust and reliable connection, ensuring that the rock step assembly remains firmly in place even during demanding off-road or overlanding activities.

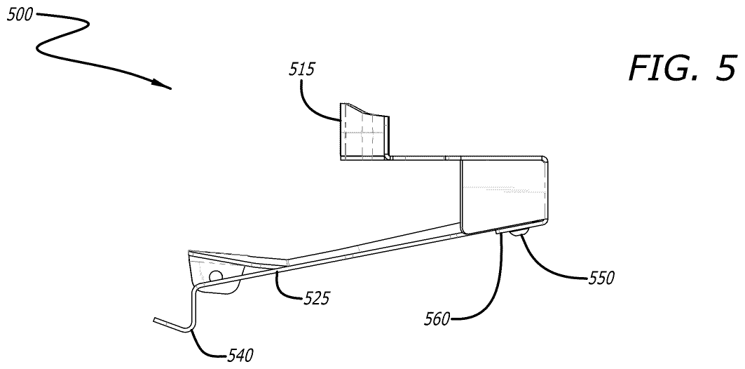

Referring to FIG. 5, a cross-sectional view of a rock step assembly 500 in accordance with various embodiments of the disclosure is shown. In some embodiments, the rock step assembly 500 may include a sturdy and durable material such as metal or reinforced plastic. From the cross-sectional perspective, those skilled in the art can observe that the thickness and strength of the assembly may be varied so as to withstand the rigors of off-road adventures and protect the vehicle's lower side. The pinch seam protection element 540 can be seen in a shape that can be configured to cover a pinch seam of a vehicle. The upper mounting surface 515 and lower mounting surface 525 can be seen in profile that extend along the length of the rock step assembly 500.

Furthermore, in some embodiments, a layered construction may be implemented. To that end, multiple layers or sections may contribute to the rock step assembly's overall strength and functionality. In some embodiments, these layers may include a protective outer surface, designed to withstand impact and resist scratches or damage from rocks, debris, or rough terrain. Beneath the outer layer, an additional reinforcement layer or structural elements may be included that provide stability and ensure the rock step assembly's long-lasting performance. In some embodiments, a method of manufacturing a rock step assembly may comprise carefully selecting one or more high-quality metals or other durable materials known for robustness and ability to withstand harsh environments.

In some embodiments, the drainage channels or openings are strategically disposed to facilitate the efficient flow of water, mud, or debris. In some embodiments, various mounting brackets and hardware may be used to secure the assembly to the vehicle's frame or body, ensuring a secure and reliable installation. Drainage openings may be strategically positioned to ensure efficient water drainage and prevent water accumulation. In some embodiments, a metal sheet or tube is cut to a required size and shape based on the configuration. It is envisioned that a press brake or any of various tube bending machines may be used to bend the material into the desired shape for the rock step assembly. For example, the metal may be clamped between a punch and a die, and pressure may be applied to bend it accurately according to the desired configuration.

In some embodiments, if any component pieces of the rock step assembly comprise multiple pieces or additional components, welding may be used to join them securely. These pieces may be joined by utilizing a plurality of two-piece fasteners 550 at a two-piece overlap portion 550. Any sharp edges or burrs caused by the cutting and bending process may also be removed in some embodiments. Furthermore, various surface treatments, such as powder coating or painting, to enhance the appearance and protect the metal from corrosion may be used.

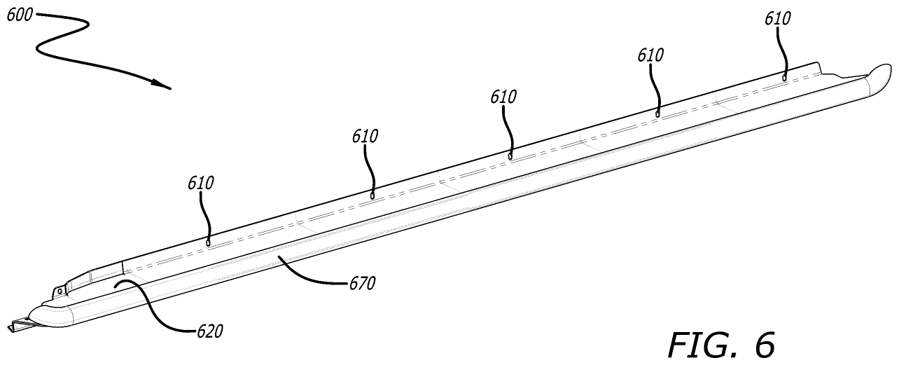

Although a specific embodiment for a vehicle rock step assembly suitable for carrying out the various steps, processes, methods, and operations described herein is discussed with respect to FIGS. 1-5, any of a variety of systems and/or processes may be utilized in accordance with embodiments of the disclosure. For example, the rock slider assembly depicted in FIGS. 6-10 may also be interchangeable with other elements of FIGS. 1-5 as required to realize a particularly desired embodiment.

Referring to FIG. 6, an isometric view of a rock slider assembly 600 in accordance with various embodiments of the disclosure is shown. In some embodiments, the rock step assembly 600 may be configured as a rock slider. In this configuration, the assembly may comprise a substantially tubular shape, including rounded edges that promote smooth contact with rocks and other obstacles encountered during off-road adventures. This configuration enhances the vehicle's off-road capabilities, providing an additional layer of protection for the lower side and rocker panels. In more embodiments, the rock step assembly 600 can include a plurality of upper mounting locations 610, lower mounting locations (not shown), and a platform 620.

In some embodiments, the rounded edges minimize the chances of the rock slider assembly 600 getting caught or snagged on rocks, thereby reducing the risk of damage to both the assembly and the vehicle. This facilitates a sliding motion, allowing the vehicle to glide over rocks and uneven terrain with reduced friction and potential impact. Additionally, the tubular configuration of the rock slider 670 provides enhanced structural strength and integrity. In many embodiments, the rock step assembly 600 may comprise any of various materials, including steel or aluminum, without limitation. Such materials help ensure that the assembly can withstand forces and impacts encountered during off-road driving. Furthermore, in some embodiments, the tubular configuration disperses the load and impact forces, effectively protecting the vehicle's rocker panels from potential damage caused by rocks, tree stumps, or other obstacles. In some embodiments, the rock slider 670 and associated configuration of the assembly complements the vehicle's rugged aesthetic, by giving a more aggressive and purpose-built appearance. It not only serves as a functional protective measure but also adds to the overall visual appeal of the vehicle.

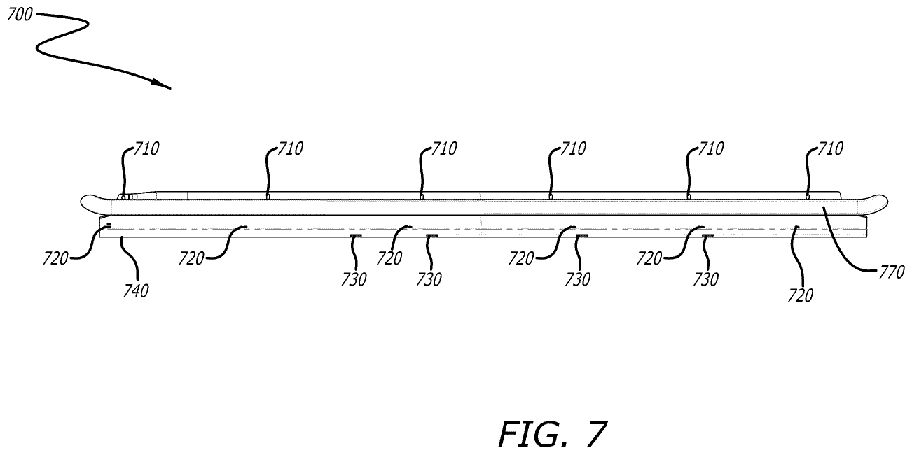

Referring to FIG. 7, a side perspective view of a rock slider assembly 700 in accordance with various embodiments of the disclosure is shown. In some embodiments, the tubular portion of the rock slider assembly 700 may be configured with winged or raised sections on opposing ends, thereby offering an additional advantage of increased ground clearance. This feature allows the vehicle to navigate challenging terrain with greater case and reduced risk of grounding out. Similar to the rock step assembly 200 shown in FIG. 2, the rock slider assembly 700 can include a plurality of upper mounting locations 710, lower mounting locations 720, drainage openings 730 and a pinch seam protection element 740.

In various embodiments, by elevating the outer edges of the rock slider, obstacles such as rocks, logs, or uneven terrain can be traversed more effectively, providing enhanced off-road capabilities, and minimizing the potential for damage to the vehicle's undercarriage. This winged or raised configuration adds to the versatility and functionality of the rock slider assembly, making it a valuable addition for off-road enthusiasts seeking optimal ground clearance and protection.

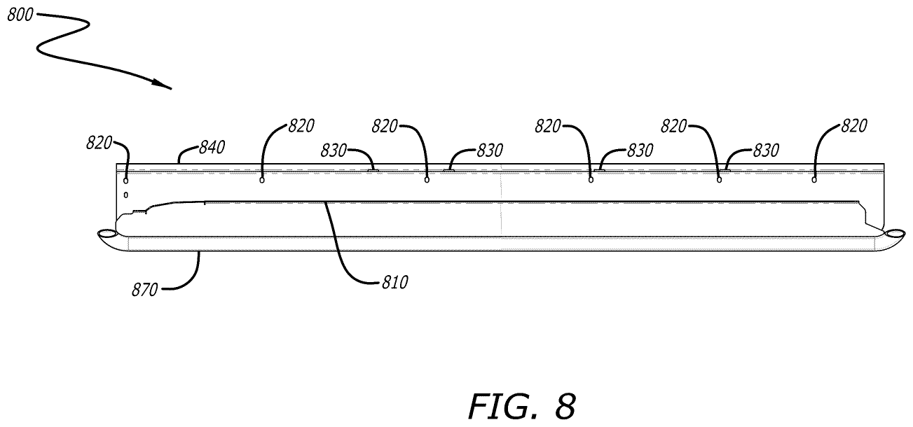

Referring to FIG. 8, a side perspective view of a rock slider assembly in accordance with various embodiments of the disclosure is shown. The rock slider 870 can be configured to extend to the edge of a platform. In more embodiments, the lower edge of the rock step assembly may be configured to wrap around a pinch seam of the vehicle. A plurality of upper mounting locations 810, lower mounting locations 820, and drainage openings 830 can be disposed along the rock slider assembly 800. In some embodiments, the lower edge of the rock slider assembly 800 may be configured to wrap around a pinch seam of the vehicle. As discussed above, the pinch seam, also known as a rocker panel seam, generally refers to the area where the body panels of a car or truck come together, typically located along the lower edge of the vehicle's side. It is a structural feature that helps maintain the vehicle's integrity and rigidity.

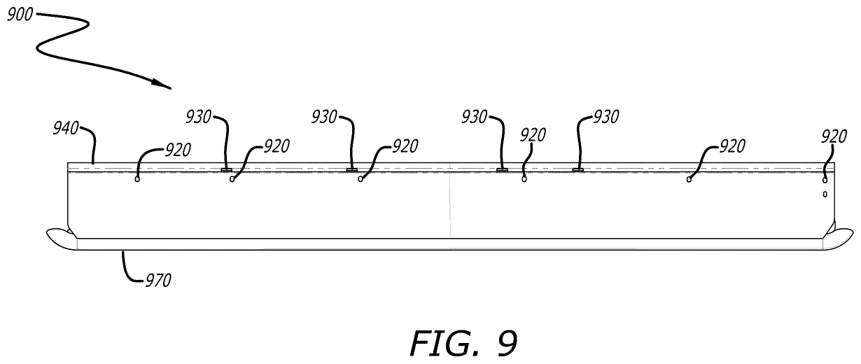

Referring to FIG. 9, a lower perspective view of a rock slider assembly 900 in accordance with various embodiments of the disclosure is shown. In some embodiments, the rock slider assembly 900 offers flexibility in its construction, available in both multi-piece and one-piece configurations. In various embodiments, either design can have a plurality of lower mounting locations 920, drainage openings 930 and a pinch seam protection element 940 disposed along the length of the rock slider assembly 900. In some embodiments, the rock slider 970 may be welded, extruded, or otherwise attached to another piece of the rock slider assembly 900. In a two-piece construction, for example, the rock slider assembly 900 may include separate components that are configured to couple together seamlessly. These components may overlap in certain regions, allowing for the use of fasteners such as bolts or screws through pre-drilled holes. The overlapping design ensures a secure and sturdy connection between the different parts of the rock slider assembly 900.

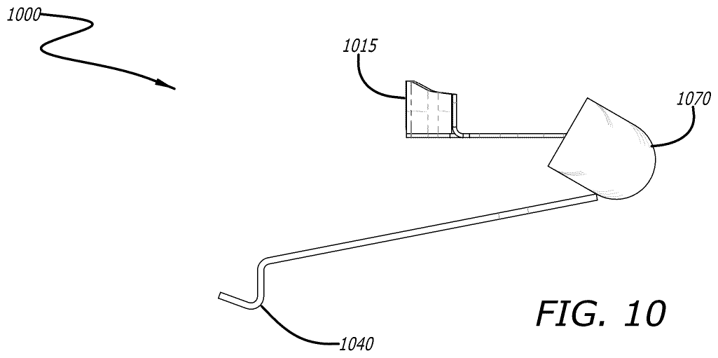

Referring to FIG. 10, a cross-sectional view of a rock slider assembly 1000 in accordance with various embodiments of the disclosure is shown. In some embodiments, the rock slider assembly 1000 may include a sturdy and durable material such as metal or reinforced plastic. From the cross-sectional perspective, those skilled in the art can observe that the thickness and strength of the assembly may be varied so as to withstand the rigors of off-road adventures and protect the vehicle's lower side. Specifically, an upper mounting surface 1015 and a pinch scam protection element 1040 is shown along with the rock slider 1070 that are all disposed along the length of the rock slider assembly 1000.

Although a specific embodiment for a vehicle rock slider assembly suitable for carrying out the various steps, processes, methods, and operations described herein is discussed with respect to FIGS. 6-10, any of a variety of systems and/or processes may be utilized in accordance with embodiments of the disclosure. For example, the rock step assembly depicted in FIGS. 1-5 may also be interchangeable with other elements of FIGS. 6-10 as required to realize a particularly desired embodiment.

Although the present disclosure has been described in certain specific aspects, many additional modifications and variations would be apparent to those skilled in the art. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A rock step assembly, comprising:
a platform;
an upper mounting element, wherein the upper mounting element comprises a plurality of upper mounting locations;
a lower mounting element, wherein the lower mounting element comprises a plurality of lower mounting locations;
a plurality of drainage openings; and
a pinch seam protection element.

2. The rock step assembly of claim 1, wherein the platform comprises an upper portion and a lower portion.

3. The rock step assembly of claim 2, wherein the upper mounting element is disposed along the length of the upper portion.

4. The rock step assembly of claim 3, wherein the lower mounting element is disposed along the length of the lower portion.

5. The rock step assembly of claim 4, wherein the pinch seam protection element extends from the lower mounting element.

6. The rock step assembly of claim 5, wherein the pinch seam protection element is configured to cover the pinch seam of a vehicle.

7. The rock step assembly of claim 6, wherein the pinch seam protection element covers the pinch seam of a vehicle by being deformed to surround the pinch seam.

8. The rock step assembly of claim 1, wherein the platform comprises a first part and a second part.

9. The rock step assembly of claim 8, wherein the first part and the second part are configured to interconnect at an overlap portion.

10. The rock step assembly of claim 9, wherein the first part and the second part are fastened to each other via a plurality of fasteners applied at the overlap portion.

11. The rock step assembly of claim 1, wherein the assembly is metal.

12. The rock step assembly of claim 1, wherein the assembly is reinforced plastic.

13. The rock step assembly of claim 1, wherein the assembly comprises multiple layers.

14. The rock step assembly of claim 13, wherein a first layer is disposed on the exterior of the assembly.

15. The rock step assembly of claim 14, wherein the second layer is disposed interior to the first layer.

16. The rock step assembly of claim 15, wherein the first layer is made from a material to enhance durability and the second layer is made from a material to reinforce the assembly.

17. A rock slider assembly, comprising:
a platform, wherein the platform comprises a substantially tubular shape;
an upper mounting element, wherein the upper mounting element comprises a plurality of upper mounting locations;
a lower mounting element, wherein the lower mounting element comprises a plurality of lower mounting locations;
a plurality of drainage openings;
a pinch seam protection element; and
wherein the rock slider assembly is crafted from a single piece of material.

18. The rock slider assembly of claim 17, wherein the shape of the rock slider assembly is shaped by a tube bending machine.

19. The rock slider assembly of claim 18, wherein the tube bending machine is a press brake.

20. The rock slider assembly of claim 17, further comprising a powder coating applied to the exterior of the rock slider assembly.
